(19) United States
(12) Patent Application Publication
(10) Pub. No.: US 2008/0101223 A1
(43) Pub. Date: May 1, 2008

(54) METHOD AND APPARATUS FOR PROVIDING NETWORK BASED END-DEVICE PROTECTION

(76) Inventor: Gustavo de los Reyes, Fair Haven, NJ (US)

Correspondence Address: Mr. John Etchells;AT&T Enterprise Services, Inc., Room 2A-207, One AT&T Way, Bedminster, NJ, 07921, US

(21) Appl. No.: 11/554,464

(22) Filed: Oct. 30, 2006

(51) Int. Cl. H04L 12/26

(52) U.S. Cl. 370/230; 370/235; 370/389; 370/401

(57) ABSTRACT

A method and apparatus for providing network based end-device protection on networks are disclosed. For example, the present method receives one or more packets, wherein the one or more packets are destined to a protected end-device (or the one or more packets are received from the protected end-device). The method then determines a type of operating system that is used by the protected end-device and then processes the one or more packets for the protected end-device in a virtual machine emulating the operating system, where the virtual machine is deployed in a communication network. Finally, the method determines whether the one or more packets processed in the virtual machine comprises at least one malicious packet.

The present invention relates generally to the protection of end devices or endpoint devices and, in particular, to a method and apparatus for providing network based end-device protection on networks such as packet networks.

### BACKGROUND OF THE INVENTION

Much of today's important business and customer applications rely on communications infrastructures such as the Internet. Businesses and consumers need to provide protection to their end-devices such as computers, cell phones, personal digital assistants (PDAs), wireless devices that support emails and instant messaging, and the like, from hostile activities while being able to communicate with others via a communications infrastructure. For example, a protected computer may deny access to users performing unauthorized tasks or blocks one or more packets from being received. However, the protection of each computer is generally based on a security or protection software executing on each end-device. For example, software may be installed on the end-device that analyzes incoming traffic and blocks malicious traffic. The malicious activity is identified based on known attack signatures, patterns, templates, policy, etc. As more and more types of end-devices are being introduced, customers are required to download and update software specific to the operating system in each end-device. The updates may not be performed due to a lack of familiarity with the varieties of operating systems or a lack of knowledge for proper installation or configuration of protection software. Furthermore, some end-devices may not have adequate memory and/or processing power to take advantage of protection software or frequent updates of software. For example, a customer may update the operating system on an end-device and may not be able to upgrade protection software due to memory and/or processing power limitations. In another example, a customer may not be knowledgeable about the latest attacks and consequently may not be diligent about performing the software updates.

Therefore, there is a need for a method and apparatus for providing network based end-device protection.

### SUMMARY OF THE INVENTION

In one embodiment, the present invention discloses a method and apparatus for providing network based end-device protection. For example, the present method receives one or more packets, wherein the one or more packets are destined to a protected end-device (or the one or more packets are received from the protected end-device). The method then determines a type of operating system that is used by the protected end-device and then processes the one or more packets for the protected end-device in a virtual machine emulating the operating system, where the virtual machine is deployed in a communication network. Finally, the method determines whether the one or more packets processed in the virtual machine comprises at least one malicious packet. A virtual machine in this invention means a device that has the important characteristics of the protected end-device and is deployed in the communication network.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with network based end-device protection;

FIG. 3 illustrates a flowchart of a method for network based end-device protection; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing network based end-device protection in networks such as packet networks, e.g., Voice over Internet Protocol (VoIP) and Service over Internet Protocol (SoIP) networks. Although the present invention is discussed below in the context of IP networks, the present invention is not so limited. Namely, the present invention can be used for other networks such as the cellular network, and the like.

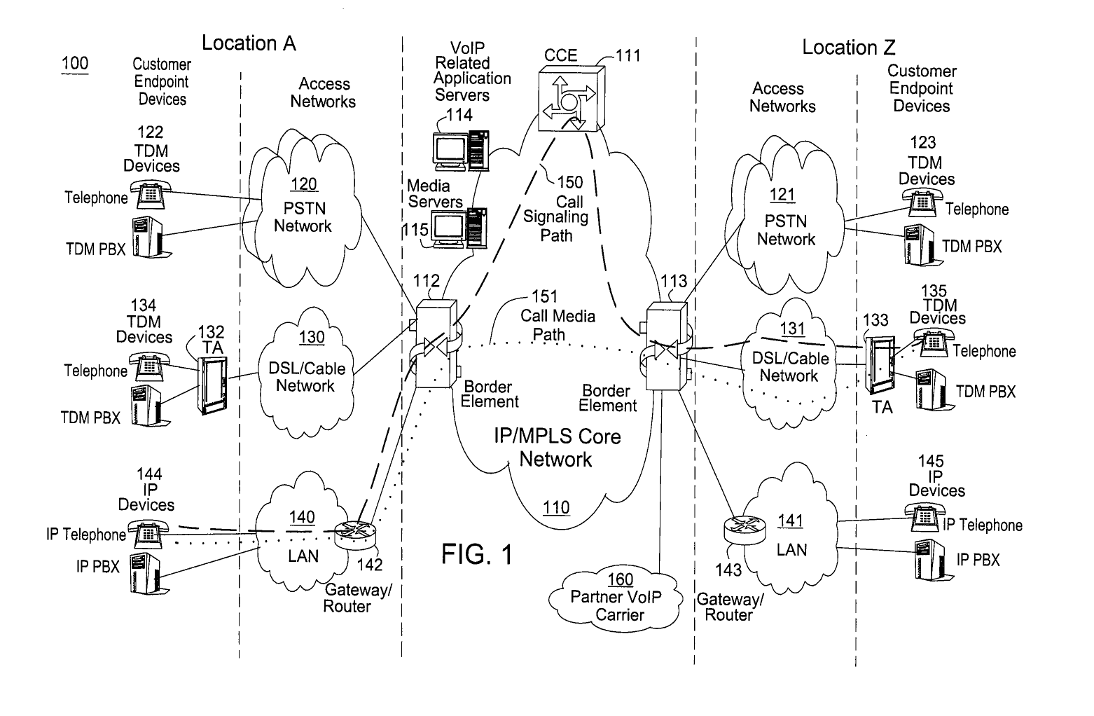

To better understand the present invention, FIG. 1 illustrates an exemplary network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a SoIP network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on. For calls that originate or terminate in a different carrier, they can be handled through the PSTN 120 and 121 or the Partner IP Carrier 160 interconnections. A customer in location A using any endpoint device type with its associated access network type can communicate with another customer in location Z using any endpoint device type with its associated network type.

The above IP network is described to provide an illustrative environment in which packets are transmitted on communication networks. Much of today's important business and consumer applications rely on communications infrastructures such as the Internet. Businesses and consumers need to provide protection to their end-devices such as computers, cell phones, personal digital assistants (PDAs), wireless devices that support emails and instant messaging and the like, from hostile activities while being able to communicate with others. For example, a protected computer may deny access to users performing unauthorized tasks or block one or more packets from being received.

A method for protecting end-devices is generally based on protection software executing on the end-devices. For example, software may be installed on an end-device that analyzes incoming traffic and blocks malicious traffic. The malicious activity is often identified based on known attack signatures, patterns, templates, etc. For example, a computer may utilize antivirus software to find and to remove infected files. The protection of the end-device from a virus depends on whether or not the latest virus definitions in the downloaded software include codes for detecting the particular virus. That is, the virus definitions are required to be updated often by the customer to include the latest known attacks. Malicious activity can also be identified by policy-based software that detects what action a packet is attempting to perform on the end-device.

A method for protecting networks is generally based on protection software executing on a network server, e.g., executing firewalls, anti-spam software, anti-phishing software, Universal Resource Locator (URL) filtering software, etc. As such, these network protection software are generally designed to protect the networks from malicious activities that may impact the performance of the networks.

Thus, effective protection of the network and the end devices generally require separate software that are distinctly designed and separately deployed to protect the network or the end devices. As more and more types of end-devices are being introduced, customers are required to download and update protection software specific to the operating system in each type of end-device. Unfortunately, the updates on end-devices may not be performed due to a lack of familiarity with the varieties of operating systems or a lack of knowledge for proper installation of the protection software. Furthermore, some end-devices may not have adequate memory and/or processing power to take advantage of frequent updates. For example, a customer may easily update protection software on computers, but the customer may not be able to easily update software in cell phones, Personal Digital Assistant (PDA), wireless devices that support emails and instant messaging, e.g., BlackBerry devices, etc. In another example, a customer may not be knowledgeable about the latest attacks and consequently may not be diligent about performing the software updates. In other cases, the customer may not know how to configure the software to provide the best protection. Therefore, there is a need for a method and apparatus for providing network based end-device protection.

In order to better describe the present invention, the following networking terminologies will first be provided:
Malware; and
Computer virus.

“Malware” refers to computer programs intended for malicious activity such as viruses, worms, spywares, Trojans, etc. Computer virus refers to a type of malware that replicates itself and spreads without the permission or knowledge of the user.

Viruses and other types of malware often spread by taking advantage of vulnerabilities in the operating systems of the end-devices. The malware is often coded to attack a specific type of operating system. For example, a computer running a Microsoft Windows operating system may not be impacted by a virus designed to attack the operating system of BlackBerry devices and a computer may spread the virus to the BlackBerry device via an email message unknowingly. Table-1 provides examples of viruses that target wireless end-devices with Symbian operating systems.

TABLE 1
Examples of Virus Attacks on Wireless End-device.

| | | Operating |
|---|---|---|
| Virus | Type of Attack | System |
| Cabir | It is packed in installation file (.sis), it sends | Symbian |
| | itself to devices in discoverable mode. | |
| Skulls | It is packed in installation file (.sis) that | Symbian |
| | replaces built in system applications with non- | |
| | functional versions. | |
| Lasco | It replicates over Bluetooth and arrives in | Symbian |
| | messaging inbox as velasco.sis. | |
| Mabir | It is based on same source as Cabir and | Symbian |
| | spreads over Bluetooth. | |
| Doomboot | It prevents phone from booting and the user | Symbian |
| | has about 1 hour before the phone dies and | |
| | all data is lost. | |

Countermeasures against malicious attacks on end-devices may require installation of software, e.g., McAfee anti-virus software, SMobile VirusGuard for protection of mobile devices, etc., on the end-devices. However, users of wireless end-devices such as cell phones, PDAs, etc. often view these end-devices as disposable gadgets. When new end-devices reach the market, customers often buy these new end-devices without giving much consideration to the operating system that is deployed in the new end-devices. As such, operating system maintenance (e.g., updating anti-virus software) for these end-devices is often neglected by the customers. Furthermore, when an end-device is attacked, the countermeasure against the attack may require the device to be operable. For example, if a BlackBerry like device is attacked by the virus Doomboot and the user is unaware of the attack for one hour, it is possible that the device may no longer be operable, where launching a countermeasure application or installing an update may no longer be possible.

In one embodiment, the present invention provides a method for providing a network based end-device protection by implementing virtual machines that emulate operating systems written for various end-device architectures. These operating systems that normally run on end-devices are then able to run on the virtual machines located in the service provider's network. Table 2 provides examples of end-device operating systems that may be emulated on a device, e.g. a computer or an application server, located in a service provider's network. It should be noted that Table 2 is not intended to provide an exhaustive listing of all available end-device operating systems.

TABLE 2
Examples of end-device operating systems
Operating System (OS)

DOS from IBM Corp.
Unix from AT&T, HP, etc.
OS/2 from Microsoft
Windows XP from Microsoft
Windows Vista from Microsoft
Windows CE from Microsoft
Linux (free operating system)
Solaris Operating system from SUN Microsystems
Mac OS from Apple Computer
Symbian operating system from SymbianOne for wireless devices
PALM operating system for Personal Digital Assistant (PDA) devices
TinyOS for wireless sensor networks
BlackBerry from Research In Motion (RIM) Limited

In one embodiment, the service provider may also implement end-device protection software, e.g., McAfee antivirus software, SMobile VirusGuard on the virtual machines. For example, computers may use McAfee antivirus software while wireless devices such as BlackBerry like devices, cellular phones, and the like may use SMobile VirusGuard. The end-device protection software may then be used to determine whether or not a received packet is malicious to an end-device running a specific end-device operating system.

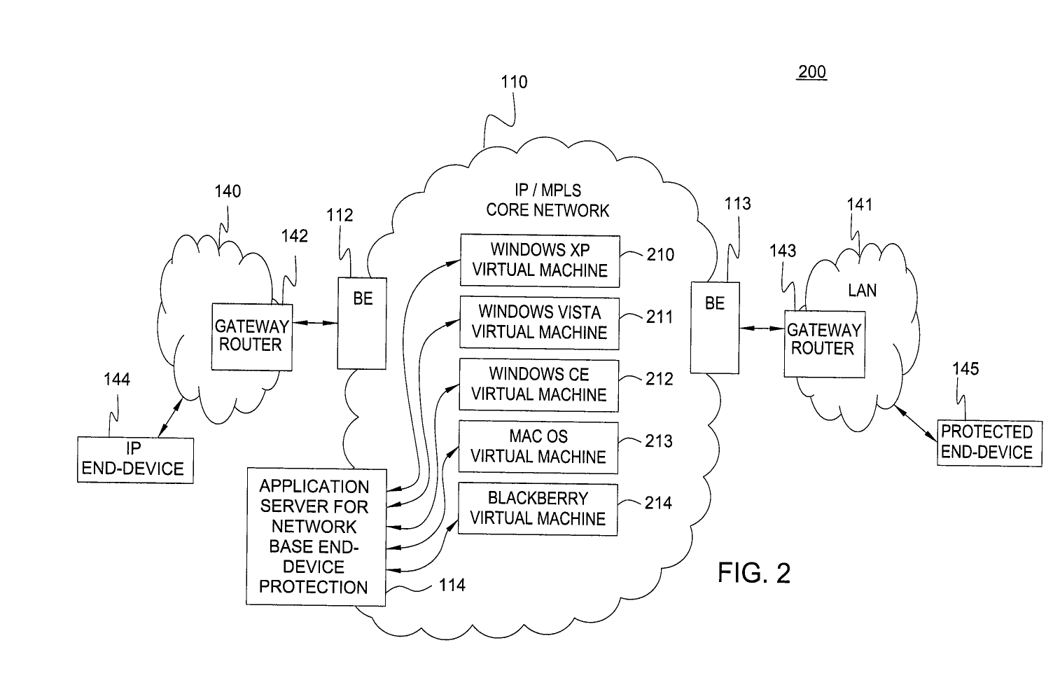

FIG. 2 illustrates an exemplary network 200 implementing the present method for network based end-device protection. For example, an IP end-device 144 is connected to a LAN 140. Packets originated by IP end-device 144 reach an IP/MPLS core network 110 via a gateway router 142, and a BE 112. The packets traverse the IP/MPLS core network 110 from BE 112 to BE 113 towards gateway router 143 located on a LAN 141. In one embodiment, gateway router 143 routes packets destined to a protected end-device 145. In one embodiment, the protected end-device 145 accesses network services, e.g. sends and receives data and voice packets, via LAN 141. In accordance with the present invention, the core network (or alternatively the access network) may deploy a plurality of virtual machines where each virtual machine is loaded with a different end-device operating system. For example, the IP/MPLS core network 110 may contain Windows XP virtual machine 210, Windows Vista virtual machine 211, WindowsCE virtual machine 212, Mac OS virtual machine 213 and BlackBerry like (e.g., broadly wireless devices that support emails and instant messaging) virtual machine 214. The service provider may also implement software for detecting malicious packets, e.g., McAfee antivirus software, SMobile VirusGuard, etc. on the virtual machines 210-214. It should be noted that although the present disclosure refers to a plurality of virtual machines, it does not mean that each virtual machine is implemented on a separate computer or server. Those skilled in the art would realize that the present invention can be adapted into one or more devices. Virtual machine is broadly defined as a software and/or hardware module that is operating a separate end-device operating system.

In one embodiment, the service provider implements the current invention to provide network based end-device protection, e.g., in an application server 114 located in the IP/MPLS core network 110. The application server 114 may be used to interact with customers to obtain end-device information. For example, the application server 114 may gather the type of end-devices and/or operating systems being used by each protected end-device. When a packet is received, the current method determines whether or not the packet is intended for a protected end-device. If the end-device is protected, then the method forwards the packet to a virtual machine that is emulating the end-device operating system in the protected end-device. If the packet is not found to be malicious when processed by the virtual machine, then the packet is forwarded to the protected end-device. If the packet is malicious, then the packet is treated according to the agreement with the customer of the protected end-device. For example, the packet may be discarded and therefore not forwarded to the protected end-device. When a malicious packet is identified, the current invention may also notify the network operator and/or the customer with the protected end-device.

Although the above embodiment provides examples of end-device operating systems that may be emulated as well as examples of software for detecting malicious packets, the provided list is not intended to be complete or to limit the present invention. There are many other end-device operating systems as well as end-device protection software that may be deployed. Furthermore, as new end-devices are introduced, the new operating systems in the new devices would also be emulated in virtual machines located in the service provider's network.

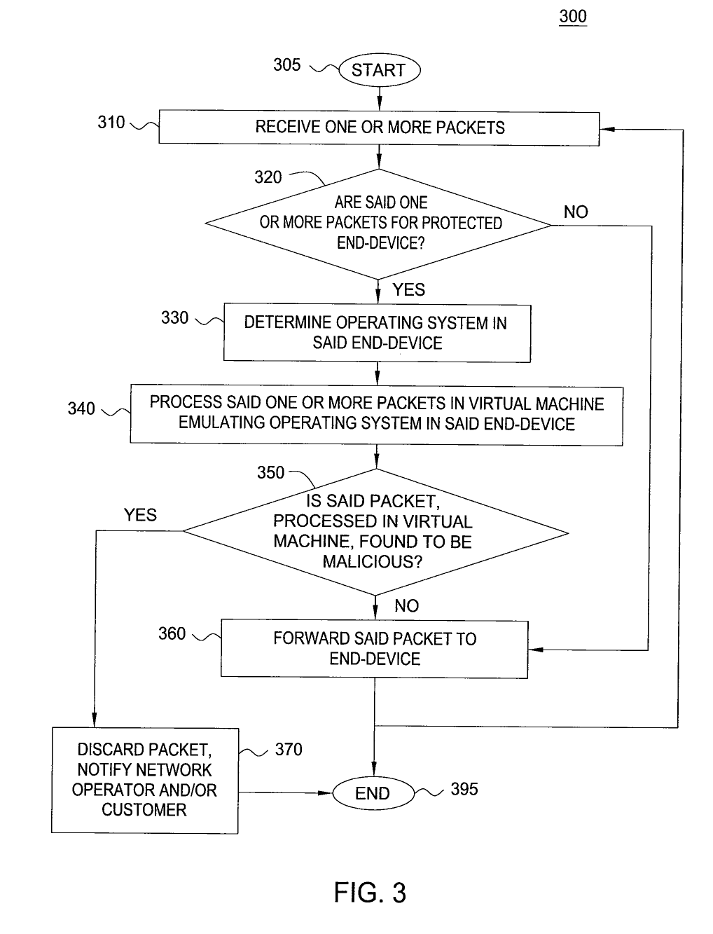

FIG. 3 illustrates a flowchart of a method 300 for providing network based end-device protection. Method 300 starts in step 305 and proceeds to step 310.

In step 310, method 300 receives one or more packets. For example, a computer may send one or more packets to a customer with a protected BlackBerry like end-device.

In step 320, method 300 determines whether or not the received packets are intended for a protected end-device. For example, the method may retrieve customer subscription information for the network based end-device protection service feature to determine whether or not the destination device is protected, i.e., whether the destination device has been subscribed by a customer to be protected by the network. If the packet is intended for a protected end-device, then the method proceeds to step 330. Otherwise, the method proceeds to step 360 to forward the packet without end-device protection.

In step 330, method 300 determines the operating system being used by the protected end-device. For example, the protected end-device may be using a BlackBerry like operating system from RIM. In another example, a customer may be using a computer with Microsoft Windows Vista operating system as an end-device and so on.

In step 340, method 300 processes the one or more packets in a virtual machine emulating the operating system in the protected end-device. For the above example of a BlackBerry device, the virtual machine emulating the BlackBerry like operating system receives and processes the packet to determine whether or not the packet is malicious.

In step 350, method 300 determines whether or not the one or more packets processed in the virtual machine are found to be malicious. For example, anti-virus software running on the virtual machine may detect a virus in the processed packet. If the one or more packets are found to be malicious, then the method proceeds to step 370. Otherwise, the method proceeds to step 360.

In step 360, method 300 forwards the one or more packets to the end-device. For example, if a non-malicious packet is received for a protected end-device, then the packet is forwarded to the protected end-device. If a packet is intended for a non-protected end-device, then the packet is simply forwarded to the end-device.

In step 370, method 300 may discard the one or more packets, and may optionally notify network operator and/or customer. For example, if a packet is found to be malicious in step 350, then the packet may be discarded and a log can be generated to document the event. The method then proceeds to step 395 to end processing of a current packet or returns to step 310 to continue receiving packets.

In one embodiment, the present method enables the virtual machines to report malicious packets. For example, a report may be used by the network service provider to perform updates in detection software, send notification to customers regarding malicious attacks, provide input to vendors of detection software, etc.

In one embodiment, the current method may notify customers when a packet intended for a protected end-device is discarded. The information may be used by the customer to update software in other end-devices, etc. For example, if a customer receives a notification that a packet intended for his/her protected BlackBerry like device has been discarded, then the customer may choose to update protection software in other end-devices that may not be protected by the network based end-device protection service.

In one embodiment, the current invention is also used to prevent malicious packets from being originated by a protected end-device. For example, the method receives packets originated by a protected end-device and processes the packets through a virtual machine emulating the end-device to determine whether or not the packets originated by the protected end-device are malicious. If a packet is determined to be malicious, then the packet may be discarded. For example, malicious packets are prevented from being forwarded through the service provider's network towards their destination. In one embodiment, the customer that originated the malicious packets via a protected end-device is notified. For example, the customer may receive a message indicating his/her end-device may have been infected with a virus, spyware, etc. This feature may be very important to some users who want to avoid the possibility that their end-devices may possibly infect other destination end-devices, e.g., end-devices that may be owned by customers and clients of the users.

In one example, a customer may have an end-device without protection software. The customer may then originate some test packets towards the network to determine whether or not the end-device has been compromised. If the current method identifies the test packet as malicious, then the customer may be notified and may invoke countermeasures.

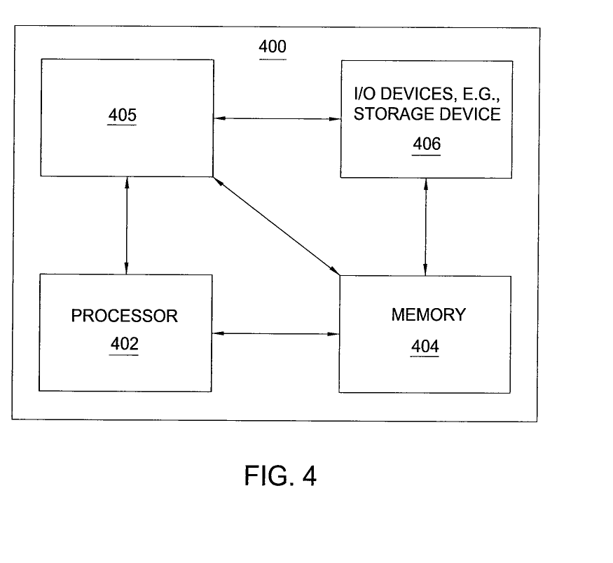

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a network based end-device protection module 405, and various input/output devices 406 (e.g., network interface cards, such as 10, 100, or Gigabit Ethernet NIC cards, Fiber Channel Host Bus Adapters, Infiniband adapters, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, or entirely in hardware, e.g., using application specific integrated circuits (ASIC), a general purpose computer or any other hardware equivalents. In one embodiment, the present network based end-device protection module or process 405 can be loaded into memory 404 and executed by processor 402 to implement the functions as discussed above. As such, the present network based end-device protection method 405 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing network based end-device protection in a communication network, comprising:
receiving one or more packets, wherein said one or more packets are destined to a protected end-device or said one or more packets are received from said protected end-device;
determining a type of operating system that is used by said protected end-device;
processing said one or more packets for said protected end-device in a virtual machine emulating said operating system, wherein said virtual machine is deployed in a communication network; and
determining whether said one or more packets processed in said virtual machine comprises at least one malicious packet.

2. The method of claim 1, further comprising:
discarding any of said one or more packets that have been identified as said at least one malicious packet.

3. The method of claim 2, further comprising:
forwarding any of said one or more packets that have been identified as said at least one malicious packet to said protected end-device.

4. The method of claim 2, further comprising:
forwarding any of said one or more packets that have been identified as said at least one malicious packet to a destination end-device.

5. The method of claim 2, further comprising:
notifying a user of said protected end-device if any of said one or more packets have been identified and are discarded.

6. The method of claim 2, further comprising:
notifying a service provider of said communication network if any of said one or more packets have been identified and are discarded.

7. The method of claim 1, wherein said communication network is a packet network.

8. The method of claim 7, wherein said packet network is an Internet Protocol (IP) network.

9. The method of claim 1, wherein said protected end-device is associated with a customer who has subscribed to a network based end-device protection service feature.

10. A computer-readable medium having stored thereon a plurality of instructions, the plurality of instructions including instructions which, when executed by a processor, cause the processor to perform the steps of a method for providing network based end-device protection in a communication network, comprising:
receiving one or more packets, wherein said one or more packets are destined to a protected end-device or said one or more packets are received from said protected end-device;
determining a type of operating system that is used by said protected end-device;
processing said one or more packets for said protected end-device in a virtual machine emulating said operating system, wherein said virtual machine is deployed in a communication network; and
determining whether said one or more packets processed in said virtual machine comprises at least one malicious packet.

11. The computer-readable medium of claim 10, further comprising:
discarding any of said one or more packets that have been identified as said at least one malicious packet.

12. The computer-readable medium of claim 11, further comprising:
forwarding any of said one or more packets that have been identified as said at least one malicious packet to said protected end-device.

13. The computer-readable medium of claim 11, further comprising:
forwarding any of said one or more packets that have been identified as said at least one malicious packet to a destination end-device.

14. The computer-readable medium of claim 11, further comprising:
notifying a user of said protected end-device if any of said one or more packets have been identified and are discarded.

15. The computer-readable medium of claim 11, further comprising:
notifying a service provider of said communication network if any of said one or more packets have been identified and are discarded.

16. The computer-readable medium of claim 10, wherein said communication network is a packet network.

17. The computer-readable medium of claim 16, wherein said packet network is an Internet Protocol (IP) network.

18. The computer-readable medium of claim 10, wherein said protected end-device is associated with a customer who has subscribed to a network based end-device protection service feature.

19. An apparatus for providing network based end-device protection in a communication network, comprising:
means for receiving one or more packets, wherein said one or more packets are destined to a protected end-device or said one or more packets are received from said protected end-device;
means for determining a type of operating system that is used by said protected end-device;
means for processing said one or more packets for said protected end-device in a virtual machine emulating said operating system, wherein said virtual machine is deployed in a communication network; and
means for determining whether said one or more packets processed in said virtual machine comprises at least one malicious packet.

20. The apparatus of claim 19, further comprising:
means for discarding any of said one or more packets that have been identified as said at least one malicious packet.
